(19) United States
(12) Patent Application Publication
(10) Pub. No.: US 2022/0300943 A1
(43) Pub. Date: Sep. 22, 2022

(54) INFORMATION PROCESSING APPARATUS, PAYMENT PROCESSING SYSTEM, METHOD, AND PROGRAM

(71) Applicant: FELICA NETWORKS, INC., TOKYO (JP)

(72) Inventors: YASUMASA NAKATSUGAWA, TOKYO (JP); ATSUO YONEDA, TOKYO (JP); TAKASHI SUZUKI, TOKYO (JP)

(21) Appl. No.: 17/633,344

(22) PCT Filed: Jul. 20, 2020
(86) PCT No.: PCT/JP2020/028144

§ 371 Date: Feb. 7, 2022

(30) Foreign Application Priority Data
Aug. 16, 2019 (JP) 2019-149492

(51) Int. Cl. G06Q 20/32; H04L 9/30; H04L 9/08; G06Q 20/38

(52) U.S. Cl. CPC G06Q 20/3278; G06Q 20/3276; H04L 9/30; H04L 9/088; G06Q 20/3825; G06Q 2220/00

(57) ABSTRACT

The present disclosure provides a configuration that enables reliable payment processing while preventing fraudulent processing even in a case where a shop terminal does not have a function to communicate with a payment server. In a payment processing system including a shop terminal and a user terminal that perform a data write process and a data read process on a data- rewritable dynamic tag, and a payment server that performs communication with the user terminal, the shop terminal writes payment data including a settlement amount and a random number into the dynamic tag. The user terminal transmits the payment data recorded in the dynamic tag to the payment server, the payment server generates a signature and transmits the signature to the user terminal after the payment processing, and the user terminal writes the signature into the dynamic tag. After that, the shop terminal verifies the signature written into the dynamic tag by the user terminal, and confirms that the payment processing has been performed.

### TECHNICAL FIELD

The present disclosure relates to an information processing apparatus, a payment processing system, a method, and a program. More particularly, the present disclosure relates to an information processing apparatus capable of performing reliable payment processing, a payment processing system, a method, and a program.

### BACKGROUND ART

Usage of easy payment processing systems using code information such as bar codes or QR codes (registered trademark) has rapidly increased in recent years.

For example, code information such as a bar code or a QR code (registered trademark) presented by the shop side can be read with a user terminal such as a user's smart phone (smartphone) equipped with a camera, and the read data can be transmitted to a payment server to make payment.

A payment processing system using the code information requires the shop side only to prepare a paper sheet on which code information such as bar codes or QR codes (registered trademark) is printed, and has the advantage of being able to greatly reduce costs and labor at the shop side.

There are various payment processing modes using such code information. For example, there is a payment processing mode in which a payment completion screen is displayed on a smartphone of the user, and the user shows the smartphone screen to a clerk of the shop so that the clerk can confirm that the payment has been completed.

In this processing, however, an unauthorized user can display a “false payment completion screen” on a smartphone. In such a case, there is a possibility that products will be taken away without actual payment.

Note that Patent Document 1 (Japanese Patent Application Laid-Open No. 2019-029017) discloses a conventional technique relating to a configuration for preventing such fraudulent processing.

Patent Document 1 discloses a configuration in which a user terminal transmits a specific session code to a payment server and a shop terminal at a time of payment processing, for example, and the payment processing is performed between the terminal and the server both holding the session code, so that fraudulent processing is prevented.

However, this configuration is based on the premise that the shop terminal can communicate with the payment server, and a small shop cannot prepare and use a shop terminal that has such a communication function.

### CITATION LIST

### Patent Document

Patent Document 1: Japanese Patent Application Laid-Open No. 2019-029017

### SUMMARY OF THE INVENTION

### Problems to be Solved by the Invention

The present disclosure is made in view of the above problem, for example, and aims to provide an information processing apparatus, a payment processing system, a method, and a program for enabling reliable payment processing even in a case where the shop side does not own a device that can communicate with a payment server.

### Solutions to Problems

A first aspect of the present disclosure lies in an information processing apparatus that includes

a data processing unit that performs a data write process and a data read process on a dynamic tag in which data is rewritable,

in which the data processing unit

writes payment data including a settlement amount and a random number into the dynamic tag, and

confirms that payment processing has been performed, by verifying a signature generated by a payment server, the signature having been written into the dynamic tag by a user terminal after the payment processing in the payment server.

Further, a second aspect of the present disclosure lies in a payment processing system that includes:

a shop terminal that performs a data write process and a data read process on a dynamic tag in which data is rewritable;

a user terminal that performs a data write process and a data read process on the dynamic tag, and performs communication with a payment server; and

the payment server that performs communication with the user terminal,

in which the shop terminal writes payment data including a settlement amount and a random number into the dynamic tag,

the user terminal transmits the payment data recorded in the dynamic tag to the payment server,

the payment server generates and transmits a signature to the user terminal, after payment processing based on the payment data,

the user terminal writes the signature received from the payment server into the dynamic tag, and

the shop terminal verifies the signature written into the dynamic tag by the user terminal, and confirms that the payment processing has been performed.

Further, a third aspect of the present disclosure lies in an information processing method implemented in an information processing apparatus,

the information processing apparatus including

a data processing unit that performs a data write process and a data read process on a dynamic tag in which data is rewritable,

in which the data processing unit

writes payment data including a settlement amount and a random number into the dynamic tag, and

confirms that payment processing has been performed, by verifying a signature generated by a payment server, the signature having been written into the dynamic tag by a user terminal after the payment processing in the payment server.

Further, a fourth aspect of the present disclosure lies in a payment processing method implemented in a payment processing system that includes:

a shop terminal that performs a data write process and a data read process on a dynamic tag in which data is rewritable;

a user terminal that performs a data write process and a data read process on the dynamic tag, and performs communication with a payment server; and

the payment server that performs communication with the user terminal,

in which the shop terminal writes payment data including a settlement amount and a random number into the dynamic tag,

the user terminal transmits the payment data recorded in the dynamic tag to the payment server,

the payment server generates and transmits a signature to the user terminal, after payment processing based on the payment data,

the user terminal writes the signature received from the payment server into the dynamic tag, and

the shop terminal verifies the signature written into the dynamic tag by the user terminal, and confirms that the payment processing has been performed.

Further, a fifth aspect of the present disclosure lies in a program for causing an information processing apparatus to perform information processing,

the information processing apparatus including

a data processing unit that performs a data write process and a data read process on a dynamic tag in which data is rewritable,

the program causing the data processing unit to perform:

a process of writing payment data including a settlement amount and a random number into the dynamic tag; and

a process of confirming that payment processing has been performed, by verifying a signature generated by a payment server, the signature having been written into the dynamic tag by a user terminal after the payment processing in the payment server.

Note that the program of the present disclosure is a program that can be provided in a computer-readable format from a storage medium or a communication medium to an information processing apparatus or a computer system that can execute various program codes, for example. As such a program is provided in a computer-readable format, processes according to the program are performed in an information processing apparatus or a computer system.

Other objects, features, and advantages of the present disclosure will be made apparent by the embodiments of the present disclosure described below and the detailed descriptions with reference to the accompanying drawings. Note that, in this specification, a system is a logical assembly of a plurality of devices, and does not necessarily mean devices with the respective components incorporated into the same housing.

According to the configuration of one embodiment of the present disclosure, even in a case where a shop terminal does not have a function to communicate with a payment server, reliable payment processing can be performed while fraudulent processing is prevented.

Specifically, for example, in a payment processing system including a shop terminal and a user terminal that perform a data write process and a data read process on a data-rewritable dynamic tag, and a payment server that performs communication with the user terminal, the shop terminal writes payment data including a settlement amount and a random number into the dynamic tag. The user terminal transmits the payment data recorded in the dynamic tag to the payment server, the payment server generates a signature and transmits the signature to the user terminal after the payment processing, and the user terminal writes the signature into the dynamic tag. After that, the shop terminal verifies the signature written into the dynamic tag by the user terminal, and confirms that the payment processing has been performed.

With this configuration, even in a case where a shop terminal does not have a function to communicate with a payment server, reliable payment processing can be performed while fraudulent processing is prevented.

Note that the advantageous effects described in this specification are merely examples, and the advantageous effects of the present technology are not limited to them and may include additional effects.

### BRIEF DESCRIPTION OF DRAWINGS

FIG. 1 is a diagram for explaining a general sequence of cashless payment using code information.

FIG. 2 is a diagram for explaining a general sequence of cashless payment using code information.

FIG. 3 is a diagram for explaining a specific example of processing to be performed in a payment processing system of the present disclosure.

FIG. 4 is a diagram for explaining a specific example of processing to be performed in the payment processing system of the present disclosure.

FIG. 5 is a diagram for explaining a specific example of processing to be performed in the payment processing system of the present disclosure.

FIG. 6 is a diagram for explaining a specific example of processing to be performed in the payment processing system of the present disclosure.

FIG. 7 is a diagram for explaining a specific example of processing to be performed in the payment processing system of the present disclosure.

FIG. 8 is a diagram for explaining a specific example of processing to be performed in the payment processing system of the present disclosure.

FIG. 9 is a diagram for explaining an example configuration of a shop terminal of the present disclosure.

FIG. 10 is a chart for explaining an example of a payment processing sequence according to the present disclosure.

FIG. 11 is a chart for explaining an example of a payment processing sequence according to the present disclosure.

FIG. 12 is a flowchart for explaining an example of a verification process sequence to be executed by the shop terminal in payment processing according to the present disclosure.

FIG. 13 is a flowchart for explaining an example of a verification process sequence to be executed by the shop terminal in payment processing according to the present disclosure.

FIG. 14 is a flowchart for explaining an example of a verification process sequence to be executed by the shop terminal in payment processing according to the present disclosure.

FIG. 15 is a diagram for explaining an example configuration of a user terminal that is used in the processing according to the present disclosure.

FIG. 16 is a diagram for explaining an example configuration of a shop terminal that is used in the processing according to the present disclosure.

FIG. 17 is a diagram for explaining an example hardware configuration of a user terminal, a shop terminal, or a payment server that is used in the processing according to the present disclosure.

### MODE FOR CARRYING OUT THE INVENTION

The following is a detailed description of an information processing apparatus, a payment processing system, a method, and a program of the present disclosure, with reference to the drawings. Note that explanation will be made in the following order.

1. Outline of payment processing using general code information

2. Configuration of a payment processing system of the present disclosure, and processing to be performed

3. Processing sequence in the payment processing system of the present disclosure

4. Specific examples and modifications of the verification processing in the shop terminal

5. Example configurations of the respective apparatuses

6. Summary of the configuration of the present disclosure

[1. Outline of Payment Processing Using General Code Information]

Before a process and a configuration according to the present disclosure are described, an outline of payment processing using general code information is first described.

As described above, usage of easy payment processing systems using code information such as bar codes or QR codes (registered trademark) has rapidly increased in recent years.

For example, code information such as a bar code or a QR code (registered trademark) presented by the shop side can be read with a user terminal such as a user's smart phone (smartphone) equipped with a camera, and the read data can be transmitted to a payment server to make payment.

A payment processing system using the code information requires the shop side only to prepare a paper sheet on which code information such as bar codes or QR codes (registered trademark) is printed, and has the advantage of being able to greatly reduce costs and labor at the shop side.

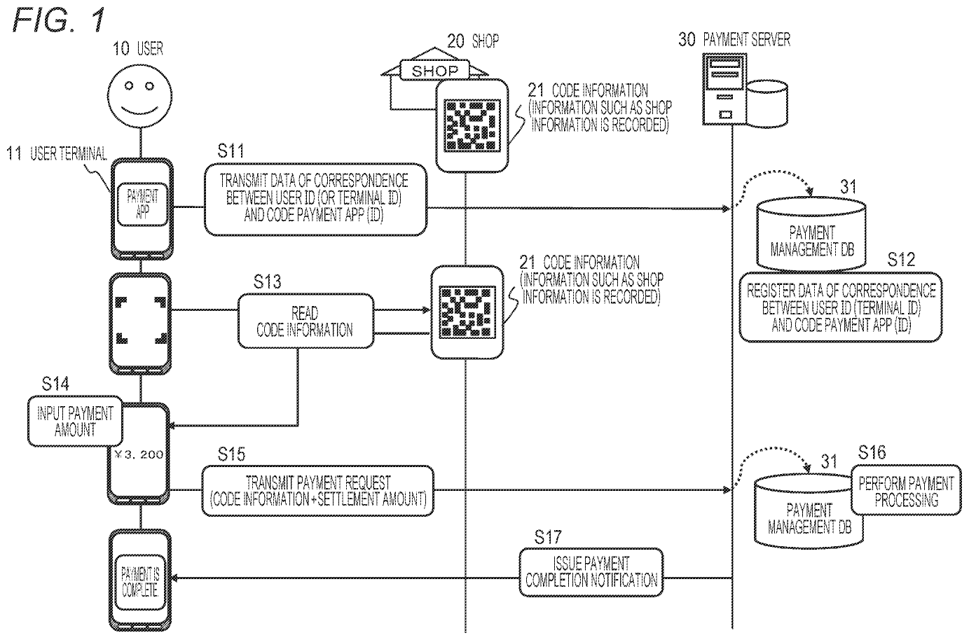

Referring now to FIG. 1, an example of a payment processing sequence using the code information is described.

FIG. 1 shows, from the left, a user terminal (a smartphone or the like) 11 of a user 10, code information 21 about a shop 20, and a payment server 30.

The processes in the respective steps in the sequence diagram are now described in order.

(Step S11)

First, in step S11, using the user terminal 11, the user 10 accesses the payment server 30, and transmits data of correspondence between the user ID (or the terminal ID) and the identifier (ID) of a code payment application (app).

The identifier (ID) of a code payment application (app) is identification information about the cashless payment means to be used by the user 10, or specifically, electronic money, a payment application, code payment, a credit card, a payment bank account, or the like.

(Step S12)

Next, in step S12, the payment server 30 records the data received from the user terminal 11, which is the data of the correspondence between the user ID (or the terminal ID) and the identifier (ID) of the code payment application (app), in a payment management database 31.

(Step S13)

Next, in step S13, using the camera function of the user terminal 11, the user 10 reads the code information 21 printed on a code information recording paper sheet provided in the shop 20. That is, imaging is performed.

The code information is code information such as a QR code (registered trademark) or bar code information, for example, and shop information such as the shop ID is recorded in the code information.

(Step S14)

Next, in step S14, the user 10 inputs the payment amount charged by a clerk of the shop 20 to the user terminal 11.

(Step S15)

Next, in step S15, using the user terminal 11, the user 10 accesses the payment server 30, and transmits a payment request.

The request to be transmitted to the payment server 30 includes code information and payment amount information.

(Step S16)

Next, in step S16, the payment server 30 acquires the data received from the user terminal 11, which is the code information and the payment amount information included in the payment request, and performs payment processing in accordance with these pieces of information.

That is, the payment processing of the payment amount is performed with the use of the cashless payment means received from the user terminal 11 in step S11. The payment amount is transferred to an account or the like of the shop side included in the code information, for example.

(Step S17)

When the payment processing is completed in step S16, the payment server 30 transmits a payment completion notification to the user terminal 11 in step S17.

A payment completion notification message is displayed on the user terminal 11, and the user has the clerk of the shop 20 confirm the payment completion notification message. Thus, the payment is completed.

By this method, however, an unauthorized user can present a “false payment completion notification message” stored beforehand in the user terminal 11, and have a clerk of the shop 20 confirm the message, without performing the processes in steps S15 and S16.

When such fraud is performed, a shop clerk might erroneously determine that payment has been completed, though any payment processing has not actually been performed.

The sequence diagram described with reference to FIG. 1 is an example in which static code information recorded on paper, for example, or code information formed only with fixed information such as shop information, is used.

Next, it is also possible to adopt a configuration that dynamically generates code information including not only shop information but also payment amount information and the like every time payment processing is performed, for example, and uses such dynamic code information.

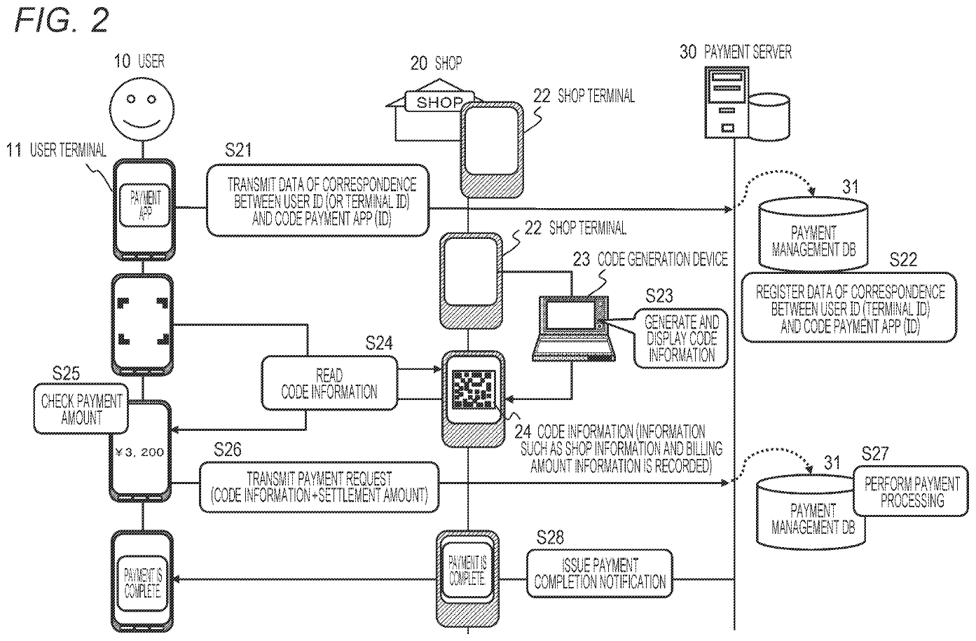

Referring now to FIG. 2, an example sequence using dynamic code information is described.

Like FIG. 1, FIG. 2 shows, from the left, a user terminal (a smartphone or the like) 11 of a user 10, code information 21 about a shop 20, and a payment server 30.

The processes in the respective steps in the sequence diagram are now described in order.

(Step S21)

First, in step S21, using the user terminal 11, the user 10 accesses the payment server 30, and transmits data of correspondence between the user ID (or the terminal ID) and the identifier (ID) of a code payment application (app).

The identifier (ID) of a code payment application (app) is identification information about the cashless payment means to be used by the user 10, or specifically, electronic money, a payment application, code payment, a credit card, a payment bank account, or the like.

(Step S22)

Next, in step S22, the payment server 30 records the data received from the user terminal 11, which is the data of the correspondence between the user ID (or the terminal ID) and the identifier (ID) of the code payment application (app), in a payment management database 31.

(Step S23)

Next, using a code generation device 23, a clerk of the shop 20 dynamically generates code information 24 including shop information, payment amount information, and the like, and displays the code information on a shop terminal 22.

The code information 24 is code information such as a QR code (registered trademark) or bar code information, for example, and is code information in which not only the shop information but also the payment amount information and the like are recorded. This code information is generated every time payment processing is performed. The code information may include payment time and date information, salesclerk information, and the like.

(Step S24)

Next, in step S24, using the camera function of the user terminal 11, the user 10 reads the code information 24 displayed on the shop terminal 22. That is, imaging is performed.

The code information includes not only the shop information but also the payment amount information and the like.

(Step S25)

Next, in step S25, the user 10 displays the payment amount information included in code information 24 on the user terminal 11, and confirms the payment amount.

Note that the code information analysis and the payment amount display process are performed by a payment application in the user terminal 11.

(Step S26)

Next, in step S26, using the user terminal 11, the user 10 accesses the payment server 30, and transmits a payment request.

The request to be transmitted to the payment server 30 includes code information and payment amount information.

(Step S27)

Next, in step S27, the payment server 30 acquires the data received from the user terminal 11, which is the code information and the payment amount information included in the payment request, and performs payment processing in accordance with these pieces of information.

That is, the payment processing of the payment amount is performed with the use of the cashless payment means received from the user terminal 11 in step S21. The payment amount is transferred to an account or the like of the shop side included in the code information, for example.

(Step S28)

When the payment processing is completed in step S27, the payment server 30 transmits a payment completion notification to the user terminal 11 in step S28.

A payment completion notification message is displayed on the user terminal 11, and the user has the clerk of the shop 20 confirm the payment completion notification message. Thus, the payment is completed.

By this method, however, an unauthorized user can also show a “false payment completion notification message” on the user terminal 11, and have a clerk of the shop 20 confirm the message, as in the process described above with reference to FIG. 1. Therefore, a shop clerk might erroneously determine that the payment has been completed, though any payment processing has not actually been performed.

Note that a payment completion notification may be transmitted from the payment server 30 to the shop terminal 22 and be displayed during the process in step S28. However, to perform this process, the shop terminal 22 needs to be designed to be capable of communicating with the payment server 30.

[2. Configuration of a Payment Processing System of the Present Disclosure, and the Processing To Be Performed]

Next, the configuration of a payment processing system of the present disclosure that solves the above problem, and the processing to be performed are described.

As described above, in the conventional payment processing systems using code information shown in FIGS. 1 and 2, there is a possibility that fraud might be conducted by a user performing a process of displaying a “false payment completion notification message”.

The payment processing system of the present disclosure is a system that can prevent such fraud, and enables reliable payment processing even when the terminal of the shop side does not have a function to communicate with a payment server.

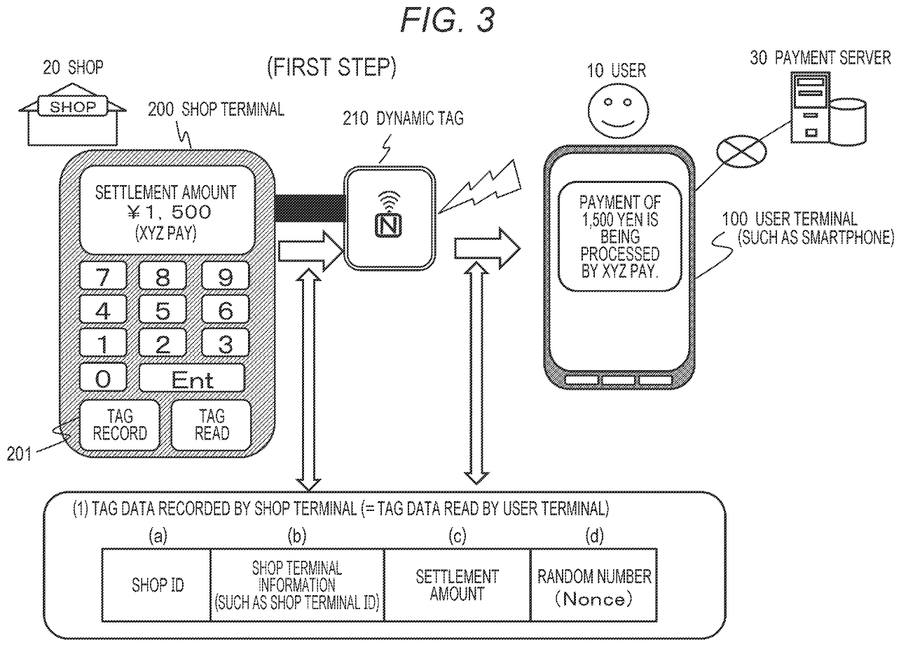

Referring to FIG. 3 and the drawings that follow, the configuration of the payment processing system of the present disclosure, and the processing to be performed described.

FIGS. 3 to 8 are diagrams for explaining a specific example of payment processing using the payment processing system of the present disclosure.

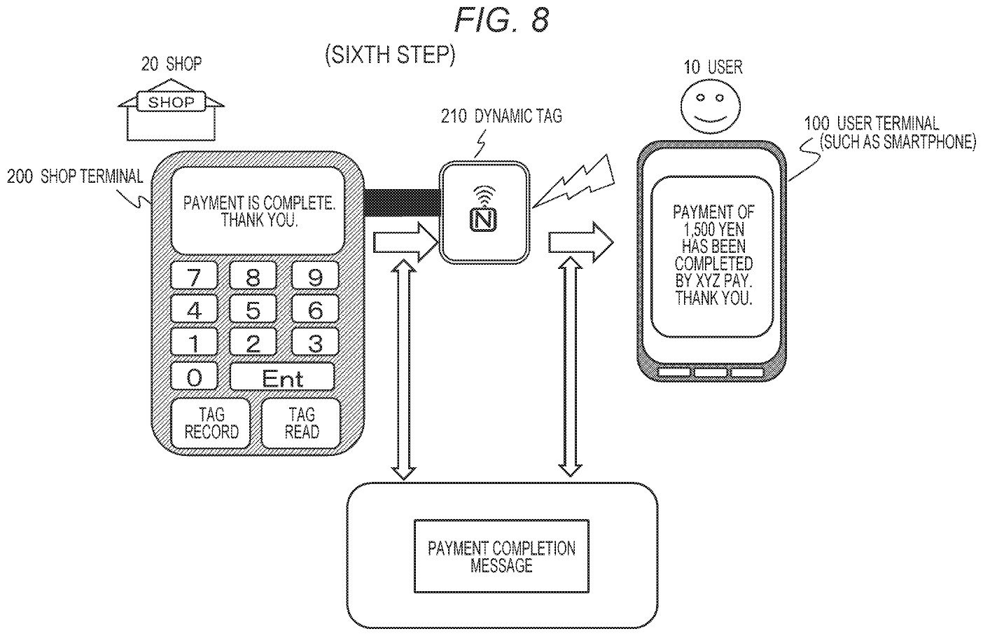

The processes in the respective steps from (first step) shown in FIG. 3 to (sixth step) shown in FIG. 8 are sequentially performed.

The processes in the respective steps are now described.

(First Step)

Before the process in a first step shown in FIG. 3 is explained, the configuration shown in FIG. 3 is described.

The user 10 shops or eats at the shop 20, and pays for it by cashless payment. The cashless payment is payment with electronic money, a payment application, code payment, a credit card, or bank account payment, or the like, for example, and actual payment processing is performed in the payment server 30 as shown in FIG. 3.

The payment server 30 can communicate with a user terminal 100 such as a smartphone owned by the user 10. However, a shop terminal 200 installed in the shop 20 does not need to have a function to communicate with the payment server 30.

However, the shop terminal 200 has a function to write data into a dynamic tag 210, and read data recorded in the dynamic tag 210.

The dynamic tag 210 is a tag having a near field communication function such as radio frequency (RF) communication or near field communication (NFC).

Alternatively, some other near field communication such as Bluetooth (registered trademark) (BT) communication may be performed.

The dynamic tag 210 performs near field communication with the user terminal 100 such as a smartphone owned by the user 10.

The dynamic tag 210 includes an internal memory. The shop terminal 200 can write data into the internal memory of the dynamic tag 210, and the shop terminal 200 can also read data recorded in the internal memory of the dynamic tag 210.

Note that, in the example shown in the drawing, the shop terminal 200 and the dynamic tag 210 are designed to be connected by a communication cable. However, the shop terminal 200 and the dynamic tag 210 may be designed not to be connected by a cable, but to perform near field communication with each other.

Alternatively, the dynamic tag 210 may be formed integrally in the shop terminal 200.

The dynamic tag 210 performs near field communication with the user terminal 100 such as a smartphone owned by the user 10.

The user terminal 100 also includes a near field communication unit for NFC or the like. The user terminal 100 can read data recorded in the memory of the dynamic tag 210 by near field communication, and can also write data into the memory of the dynamic tag 210.

The process in the first step shown in FIG. 3 is now described.

The user 10 makes cashless payment to pay for shopping or eating at the shop 20. The cashless payment is payment with electronic money, a payment application, code payment, a credit card, or bank account payment, or the like, for example, and actual payment processing is performed in the payment server 30 as shown in FIG. 3.

First, a clerk of the shop 20 inputs a settlement amount (=payment amount) to the shop terminal 200.

The input amount is displayed on the display unit of the shop terminal 200. In the example shown in the drawing, the settlement amount is 1500 yen. The cashless payment means is XYZ Pay.

Note that the cashless payment means (XYZ Pay) is a cashless payment means that is registered beforehand in the shop terminal 200 and is also registered in the user terminal 100.

Note that a cashless payment means registered in the user terminal 100 means that a cashless payment application has been downloaded into the user terminal 100, and the application can be used in the user terminal 100.

In the example shown in the drawing, cashless payment is to be made using “XYZ Pay”, which is a cashless payment means.

Note that this is an example, and the cashless payment means to be used may be any cashless payment means, such as electronic money, a payment application, code payment, a credit card, and bank account payment.

When a clerk of the shop 20 inputs the settlement amount (=payment amount) to the shop terminal 200 and touches a tag record button 201, the shop terminal 200 writes into the dynamic tag 210 “(1) tag data recorded by the shop terminal (=tag data read by the user terminal)” shown in the lower portion of FIG. 3.

Note that a settlement amount may be input directly to the shop terminal 200 by a shop clerk, but a settlement amount input by a shop clerk to a register that is an external accounting device connected to the shop terminal 200 may be transferred to the shop terminal 200.

When the settlement amount (=payment amount) is input to the shop terminal 200, and a shop clerk touches the tag record button 201, the shop terminal 200 writes into the dynamic tag 210 “(1) tag data recorded by the shop terminal” shown in the lower portion of FIG. 3.

Note that the tag record button 201 may not be formed, and “(1) tag data recorded by the shop terminal” shown in the lower portion of FIG. 3 may be automatically written into the dynamic tag 210 at the stage where the settlement amount (=payment amount) is input to the shop terminal 200.

As shown in “(1) tag data recorded by the shop terminal” in FIG. 3, the data recorded in the dynamic tag 210 includes each piece of the following data:

(a) shop ID;

(b) shop terminal information (such as shop terminal ID);

(c) settlement amount (=payment amount); and

(d) random number (Nonce).

The (a) shop ID is the identifier of the shop 20.

The (b) shop terminal information (such as the shop terminal ID) is shop terminal information such as the identifier of the shop terminal 200.

The (c) settlement amount (=payment amount) is the payment amount of the user 10, and is the amount input by a shop clerk.

The (d) random number (Nonce) is a random number (Nonce) that is generated by a data processing unit of the shop terminal 200 every time payment processing is performed.

The shop terminal 200 generates tag record data including each of these pieces of data (a) to (d), outputs the tag record data to the dynamic tag 210, and records the tag record data into the storage unit (memory) of the dynamic tag 210.

The data recorded in the storage unit (memory) of the dynamic tag 210 is transmitted to the user terminal 100 via the near field communication unit of the dynamic tag 210.

The user terminal 100 that has read the tag record data displays the specific payment data on the display unit of the user terminal 100 as shown in the drawing. This data display process is performed by the payment application (application program) in the user terminal 100.

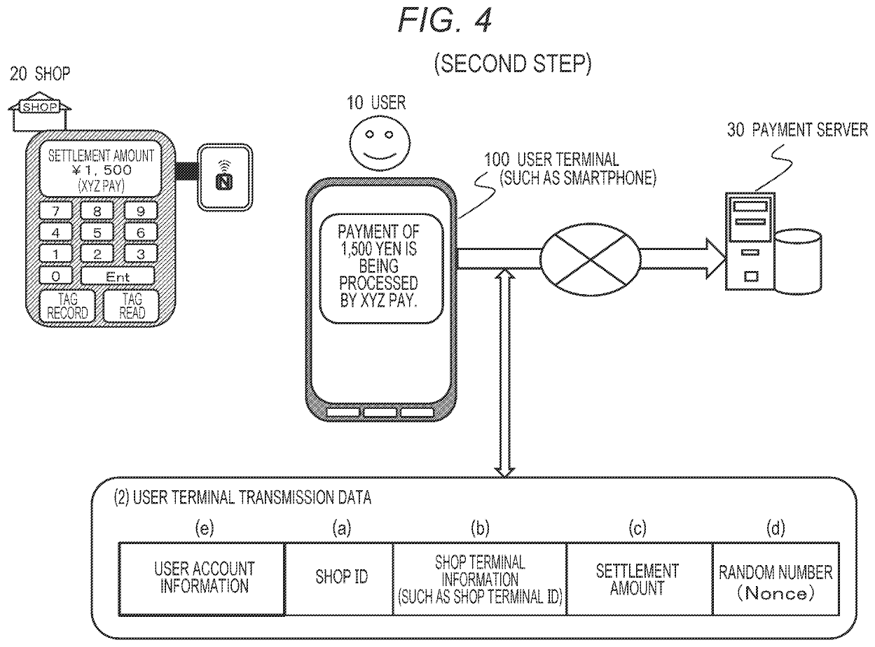

Further, the payment application in the user terminal 100 performs a process of transmitting the data read from the dynamic tag 210 to the payment server 30. This process will be described below, with reference to FIG. 4.

(Second Step)

Referring now to FIG. 4, the process in a second step is described.

As shown in FIG. 4, the process in the second step is a process of transmitting data from the user terminal 100 to the payment server 30.

The user terminal 100 generates “(2) user terminal transmission data” shown in FIG. 4, and transmits the data to the payment server 30. The (2) user terminal transmission data includes the following data:

(a) shop ID;

(b) shop terminal information (such as shop terminal ID);

(c) settlement amount (=payment amount);

(d) random number (Nonce); and

(e) user account information.

The respective pieces of data (a) to (d) are the data read by the user terminal 100 from the dynamic tag 210 in (First Step).

The user terminal 100 generates data by adding

the (e) user account information

to the tag read data (a) to (d), and transmits the data to the payment server 30.

The (e) user account information is information necessary for the user 10 in the payment processing, and includes information such as the cashless payment means to be used and the user ID.

The payment server 30 includes a user account information database in which the cashless payment means associated with the user ID and can be used by the user is recorded.

On the basis of the user account information received from the user terminal 100, the payment server 30 identifies the user who is conducting the cashless payment and the payment means to be used, and performs the payment processing.

(Third Step)

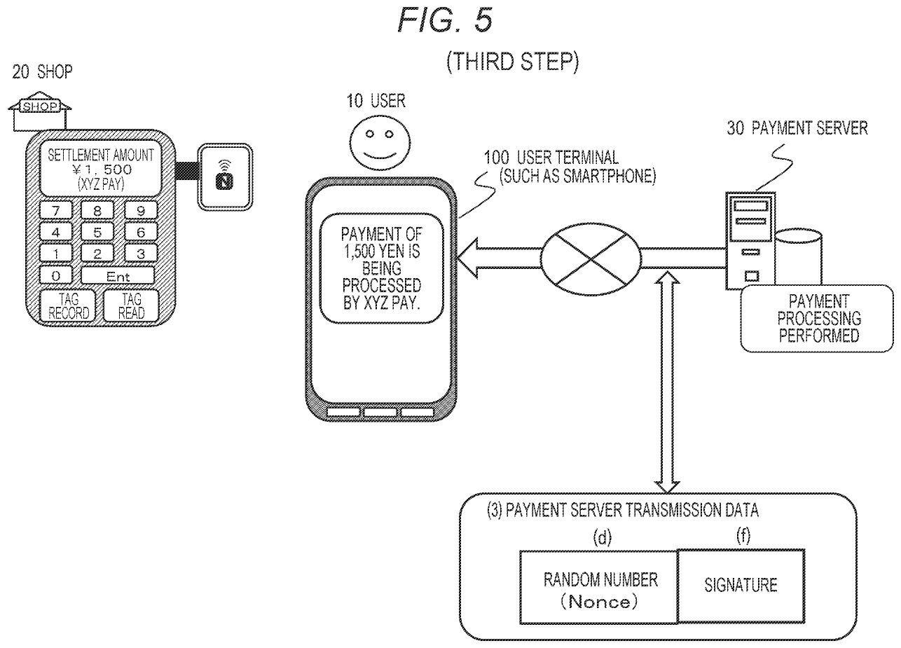

Next, the process in a third step is described with reference to FIG. 5.

The third step is payment processing in the payment server 30, and a process of transmitting data from the payment server 30 to the user terminal 100 after the payment processing.

In the previous (Second Step), the payment server 30 receives, from the user terminal 100, each piece of the following data:

(a) shop ID;

(b) shop terminal information (such as shop terminal ID);

(c) settlement amount (=payment amount);

(d) random number (Nonce); and

(e) user account information.

The payment server 30 performs the payment processing by referring to these pieces of data. That is, on the basis of the user account information, the user who is conducting the cashless payment and the payment means to be used are identified, and the payment processing of the settlement amount is performed.

The settlement amount is transferred to an account of the shop identified on the basis of the shop ID, for example.

The payment server 30 holds shop management information in which data that associates the shop ID with the shop account is recorded, for example. On the basis of the shop management information, the account of the shop is confirmed, and the transfer is performed.

When the payment processing is completed, the payment server 30 generates transmission data having a data configuration shown in “(3) payment server transmission data” in FIG. 5, and transmits the transmission data to the user terminal 100.

The “(3) payment server transmission data” includes the following data:

(d) random number (Nonce); and

(f) signature.

The (d) random number is a random number included in the data received from the user terminal 100. That is, the random number is a random number that is generated and written into the dynamic tag 210 by the shop terminal 200 in (First Step) described above with reference to FIG. 3.

The (f) signature is electronic signature data generated by the payment server 30 applying a private key to the (d) random number.

The private key is a private key known only to the payment server 30. The private key is specified by a so- called public key cryptosystem. A signature verification process can be performed with the public key corresponding to the private key.

The payment server 30 generates signature data that is encrypted data of the random number by executing an electronic signature for the random number (Nonce) with the private key stored in the storage unit of the payment server 30, and transmits the (f) signature, together with the (d) random number, to the user terminal 10.

(Fourth Step)

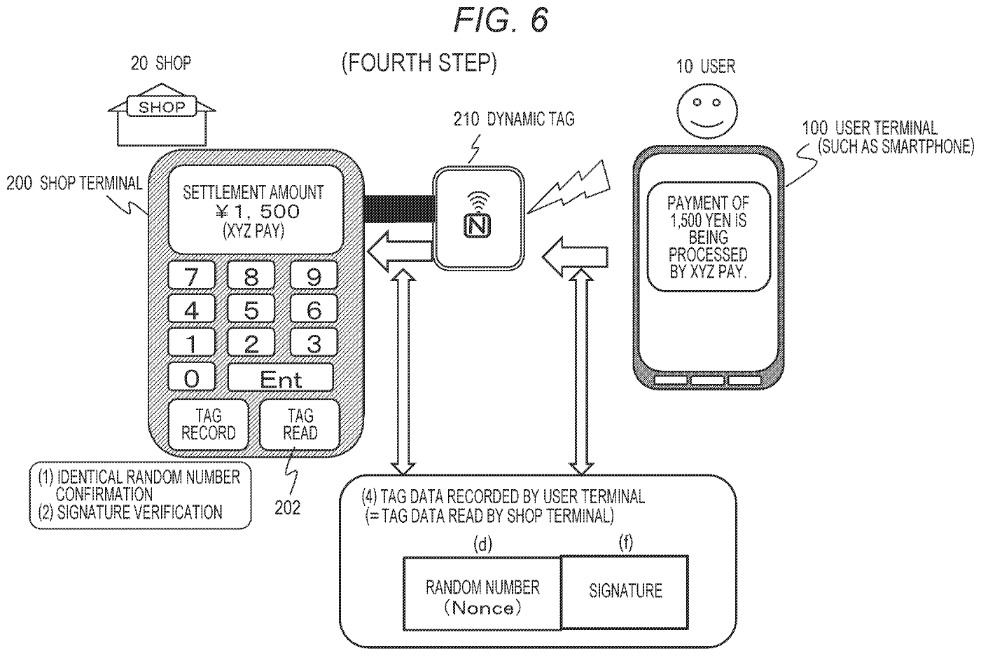

Next, the process in a fourth step is described with reference to FIG. 6.

The process in the fourth step is a processing step in which the user terminal 100 writes the data received from the payment server 30 into the dynamic tag 210, and the shop terminal 200 reads and verifies the tag-written data.

First, the user terminal 100 writes the data received from the payment server 30 into the dynamic tag 210. This tag-written data is “(4) tag data recorded by the user terminal (=tag data read by the shop terminal)” shown in FIG. 6, and includes the following data:

(d) random number (Nonce); and

(f) signature.

These pieces of data are the data received by the user terminal 100 from the payment server 30 in (Third Step) described above with reference to FIG. 5.

Next, the shop terminal 200 reads the data written into dynamic tag 210 by the user terminal 100.

For example, when a shop clerk touches a tag read button 202 of the shop terminal 200, the data recorded in the dynamic tag 210 is read by the shop terminal 200.

Note that the tag read button 202 shown in the drawing is not an essential component, and the shop terminal 200 may be designed to detect that execution of a write process and read the written data in a case where new data has been written into the dynamic tag 210 from an external terminal.

The shop terminal 200 uses the data read from the dynamic tag 210, which is:

(d) random number (Nonce); and

(f) signature.

On the basis of these pieces of read data, a verification process is performed to determine whether or not the payment processing has been performed in the payment server 30 without fail.

First, a check is made to determine whether or not the “(d) random number (Nonce)” read from the dynamic tag 210 has the same value as the random number generated by the shop terminal 200 in (First Step) described above with reference to FIG. 3.

Note that the shop terminal 200 records and holds, in the storage unit in the shop terminal 200, the random number generated by the shop terminal 200 in the (First Step) described above with reference to FIG. 3.

In a case where the “(d) random number (Nonce)” read from the dynamic tag 210 does not have the same value as the random number generated by the shop terminal 200 in (First Step) described above with reference to FIG. 3, it is determined that correct payment processing by the payment server 30 has not been performed. In this case, the shop terminal 200 outputs an error. For example, an error message is displayed on the display unit of the shop terminal 200. Alternatively, a warning alarm or the like is output.

In a case where it is confirmed that the “(d) random number (Nonce)” read from the dynamic tag 210 has the same value as the random number generated by the shop terminal 200 in (First Step) described above with reference to FIG. 3, a signature verification process is performed next.

This signature verification process is a process of verifying the “(f) signature” read from the dynamic tag 210, and is performed with the public key corresponding to the private key used by the payment server 30 in generating the signature.

The storage unit of the shop terminal 200 stores the public key corresponding to the private key used by the payment server 30 in generating the signature.

The data processing unit of the shop terminal 200 performs the signature verification process on the “(f) signature” read from the dynamic tag 210, according to a signature verification algorithm compliant with the public key cryptosystem, using the public key stored in the storage unit of the shop terminal 200.

In this signature verification process, in a case where validity of the signature is confirmed, it is determined that correct payment processing has been performed in the payment server 30.

In the signature verification process, in a case where validity of the signature is not confirmed, on the other hand, it is determined that correct payment processing has not been performed in the payment server 30. In this case, the shop terminal 200 outputs an error. For example, an error message is displayed on the display unit of the shop terminal 200. Alternatively, a warning alarm or the like is output.

In a case where

(1) confirmation of identical random numbers, and

(2) success of signature verification

are both recognized, the data processing unit of the shop terminal 200 determines that correct payment processing has been performed in the payment server 30, and moves on to the next process in (Fifth Step).

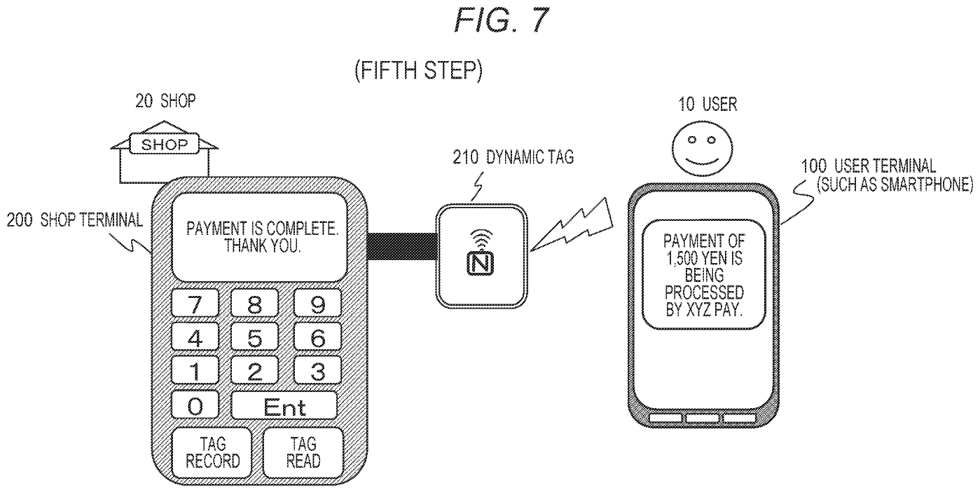

(Fifth Step) Referring now to FIG. 7, the next process in a fifth step is described.

In a case where, in (Fourth Step) described with reference to FIG. 6, the verification process performed by the shop terminal 200 on the basis of the data recorded in the dynamic tag 210 proves that correct payment processing in the payment server 30 has been performed, the shop terminal 200 issues a payment completion notification in the shop terminal 200 in

(Fifth Step).

For example, as shown in FIG. 7, the display unit of the shop terminal 200 displays the following message.

“Payment is complete. Thank you.”

As the clerk of the shop 200 and the user 10 confirm this message, both sides can confirm that the payment has been correctly performed.

Note that the process in (Sixth Step) shown in FIG. 8 may be further performed.

(Sixth Step)

Referring now to FIG. 8, the process in a sixth step is described.

The process in the sixth step is a process of transmitting a payment completion message from the shop terminal 200 to the user terminal 100, and displaying the payment completion message on the user terminal 100.

As shown in FIG. 8, the message shown below is transmitted as a payment completion message from the shop terminal 200 to the user terminal 100, for example, and is displayed on the user terminal 100.

“Payment of 1,500 yen has been completed by XYZ Pay. Thank you.”

With this message display, the user 10 can also confirm, on the user terminal 100, that the payment has been completed.

Payment processing to be performed in the payment processing system of the present disclosure has been described so far with reference to FIGS. 3 to 8.

As can be understood from these descriptions, in the system of the present disclosure, the shop terminal 200 does not need to communicate with the payment server 30. All communications with the payment server 30 are conducted by the user terminal 100.

Communications between the shop terminal 200 and the user terminal 100 are performed by data recording and reading using the dynamic tag 210.

In this payment sequence, the shop terminal 200 transmits a random number generated by the shop terminal 200, to the payment server 30 via the dynamic tag 210 and the user terminal 100.

The payment server 30 generates a random number and signature data corresponding to the random number after the payment processing, and transmits the generated data to the user terminal 100.

The shop terminal 200 receives an input of the transmission data from the payment server 30 via the user terminal 100 and the dynamic tag 210, and verifies the input data, to determine whether or not the payment processing in the payment server 30 has been correctly performed.

As these processes are performed, the shop terminal 200 that does not have a function to communicate with the payment server 30 can accurately confirm whether or not correct payment processing has been performed, and thus, fraudulent processing can be eliminated.

In the conventional cashless payment processing described above with reference to FIGS. 1 and 2, fraud can be conducted by presenting a “false payment completion screen” on the user terminal.

In the processing according to the present disclosure described with reference to FIGS. 3 to 8, on the other hand, the shop terminal 200 performs a verification process based on the data (a random number and a signature) received from the payment server 30 via the user terminal 100 and the dynamic tag 210, and determines whether or not correct payment has been performed.

The data received from the payment server 30 includes signature data to which the private key held only by the payment server is applied, and this signature data is data that cannot be generated by a third party that does not have the secret key. Thus, fraudulent processing can be prevented without fail.

Note that, although the shop terminal 200 and the dynamic tag 210 are separate components in the processing described with reference to FIGS. 3 to 8, the dynamic tag 210 may be integrated in the shop terminal 200 as mentioned above.

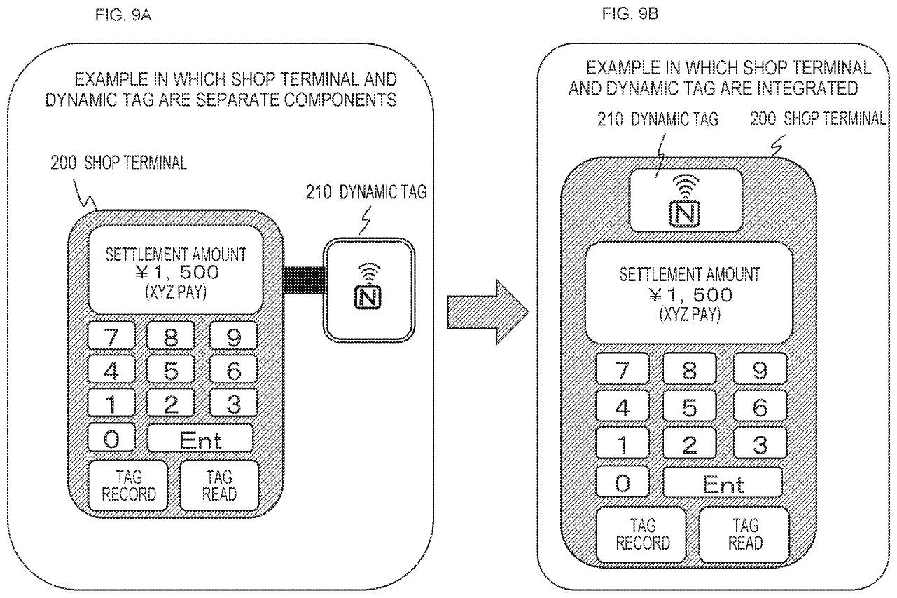

For example, as shown in FIG. 9(b), the dynamic tag 210 can be integrated in the shop terminal 200.

[3. Processing Sequence in the Payment Processing System of the Present Disclosure]

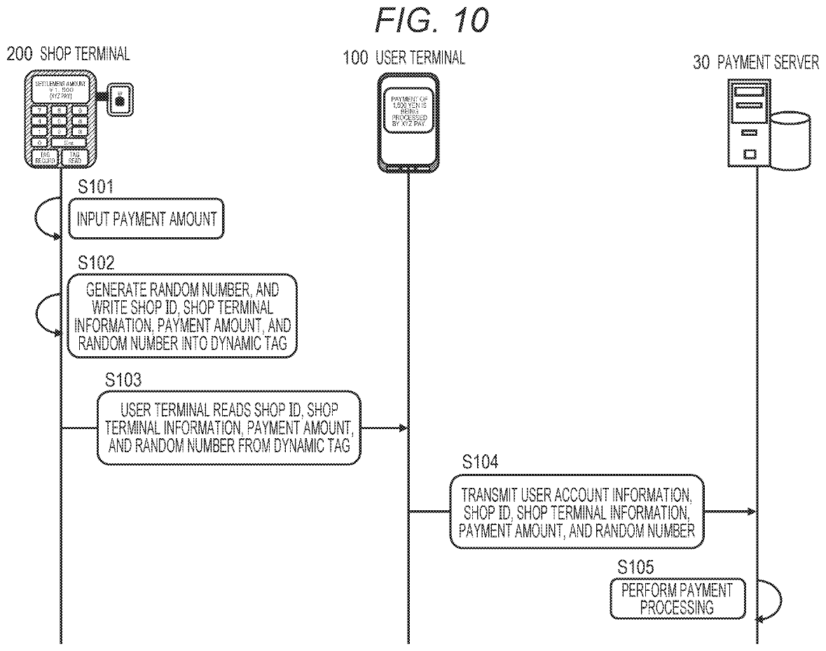

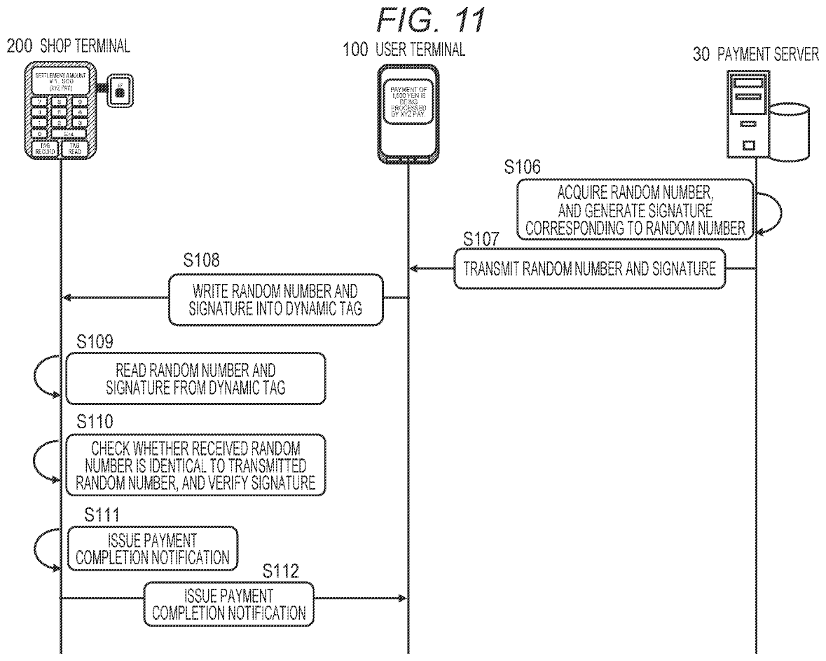

Next, a processing sequence in the payment processing system of the present disclosure is described with reference to a sequence diagram shown in FIGS. 10 and 11.

FIGS. 10 and 11 show, from the left, the shop terminal 200 installed in the shop 20, the user terminal (such as a smartphone) 100 of the user 10, and the payment server 30. The shop terminal 200 is a shop terminal that has the dynamic tag 210 connected thereto or contained therein.

The user 10 who owns the user terminal 100 performs cashless payment to pay for shopping or eating at the shop 20 in which the shop terminal 200 is installed. The cashless payment is payment with electronic money, a payment application, code payment, a credit card, or bank account payment, or the like, for example, and payment processing is performed by the payment server 30.

A cashless payment application is downloaded into the user terminal 100, and the application is in a usable state.

The processes in the respective steps in the sequence diagram are now described in order.

(Step S101)

First, in step S101, a clerk of the shop 20 inputs a settlement amount (=payment amount) to the shop terminal 200.

(Step S102)

After the clerk of the shop 20 inputs the settlement amount (=payment amount) to the shop terminal 200 in step S101, the shop terminal 200 writes the following data into the dynamic tag 210 in step S102:

(a) shop ID;

(b) shop terminal information (such as shop terminal ID);

(c) settlement amount (=payment amount); and

(d) random number (Nonce).

These pieces of data (a) to (d) are written into the dynamic tag 210.

Note that, as described above, a settlement amount may be input directly to the shop terminal 200 by a shop clerk, but a settlement amount input by a shop clerk to a register that is an external accounting device connected to the shop terminal 200 may be transferred to the shop terminal 200.

Further, the process of writing data into the dynamic tag may be performed by a shop clerk touching the tag record button 201 as described above with reference to FIG. 3, or the data (a) to (d) may be automatically written into the dynamic tag 210 at the stage where the settlement amount (=payment amount) is input to the shop terminal 200 without the use of the tag record button 201.

(Step S103)

Next, in step S103, when the user 10 brings the user terminal 100 close to the dynamic tag 210, near field communication is performed between the user terminal 100 and the dynamic tag 210, and the data recorded in the storage unit (memory) of the dynamic tag 210 is read by the user terminal 100.

That is, the user terminal 100 reads the following dynamic tag record data:

(a) shop ID;

(b) shop terminal information (such as shop terminal ID);

(c) settlement amount (=payment amount); and

(d) random number (Nonce).

(Step S104) Next, in step S104, the user terminal 100 generates transmission data including the data shown below, and transmits the transmission data to the payment server 30:

(a) shop ID;

(b) shop terminal information (such as shop terminal ID);

(c) settlement amount (=payment amount);

(d) random number (Nonce); and

(e) user account information.

The respective pieces of data (a) to (d) are the data read by the user terminal 100 from the dynamic tag 210 in step S103.

The user terminal 100 generates data by adding

the (e) user account information

to the tag read data (a) to (d), and transmits the data to the payment server 30.

The (e) user account information is information necessary for the user 10 in the payment processing, and includes information such as the cashless payment means to be used and the user ID.

The payment server 30 includes a user account information database in which the cashless payment means associated with the user ID and can be used by the user is recorded.

On the basis of the user account information received from the user terminal 100, the payment server 30 identifies the user who is conducting the cashless payment and the payment means to be used, and performs the payment processing.

(Step S105)

Next, in step S105, the payment server 30 performs the payment processing. The payment server 30 receives each piece of the data shown below from the user terminal 100, and performs the payment processing using the received data:

(a) shop ID;

(b) shop terminal information (such as shop terminal ID);

(c) settlement amount (=payment amount);

(d) random number (Nonce); and

(e) user account information.

The payment server 30 performs the payment processing by referring to the above data. That is, on the basis of the user account information, the user who is conducting the cashless payment and the payment means to be used are identified, and the payment processing of the settlement amount is performed.

The settlement amount is transferred to an account of the shop identified on the basis of the shop ID, for example.

The payment server 30 holds shop management information in which data that associates the shop ID with the shop account is recorded, for example. On the basis of the shop management information, the account of the shop is confirmed, and the transfer is performed.

(Steps S106 and S107)

After completing the payment processing in step S105, the payment server 30 next generates transmission data including each piece of the data shown below and transmits the transmission data to the user terminal 100 in steps S106 and S107:

(d) random number (Nonce); and

(f) signature.

The (d) random number is a random number included in the data received from the user terminal 100. That is, the random number is a random number that is generated and written into the dynamic tag 210 by the shop terminal 200 in step S102.

The (f) signature is electronic signature data generated by the payment server 30 applying a private key to the (d) random number.

The private key is a private key known only to the payment server 30. The private key is specified by a so-called public key cryptosystem. A signature verification process can be performed with the public key corresponding to the private key.

The payment server 30 generates signature data that is encrypted data of the random number by executing an electronic signature for the random number (Nonce) with the private key stored in the storage unit of the payment server 30, and transmits the (f) signature, together with the (d) random number, to the user terminal 10.

(Step S108)

Next, in step S108, the user terminal 100 writes the following data received from the payment server 30 into the dynamic tag 210:

(d) random number (Nonce); and

(f) signature.

Near field communication is performed between the user terminal 100 and the dynamic tag 210, and the user terminal 100 writes the above data (d) and (f) into the dynamic tag 210.

(Step S109)

Next, in step S109, the shop terminal 200 reads the data written in the dynamic tag 210, which is:

(d) random number (Nonce); and

(f) signature.

These pieces of tag-written data are read from the dynamic tag 210.

These pieces of data are the data received by the user terminal 100 from the payment server 30 in step S107.

(Step S110)

Next, in step S110, the shop terminal 200 uses the data read from the dynamic tag 210, which is:

(d) random number (Nonce); and

(f) signature.

On the basis of these pieces of read data, a verification process is performed to determine whether or not the payment processing has been performed in the payment server 30 without fail.

First, a check is made to determine whether or not the “(d) random number (Nonce)” read from the dynamic tag 210 has the same value as the random number generated earlier by the shop terminal 200 in step S102.

Note that the shop terminal 200 records and holds, in the storage unit in the shop terminal 200, the random number generated by the shop terminal 200 in step S102.

In a case where the “(d) random number (Nonce)” read from the dynamic tag 210 does not have the same value as the random number generated by the shop terminal 200 in step S102, it is determined that correct payment processing by the payment server 30 has not been performed. In this case, the shop terminal 200 outputs an error. For example, an error message is displayed on the display unit of the shop terminal 200. Alternatively, a warning alarm or the like is output.

In a case where it is confirmed that the “(d) random number (Nonce)” read from the dynamic tag 210 has the same value as the random number generated by the shop terminal 200 in step S102, a signature verification process is performed next.

This signature verification process is a process of verifying the “(f) signature” read from the dynamic tag 210, and is performed with the public key corresponding to the private key used by the payment server 30 in generating the signature.

The storage unit of the shop terminal 200 stores the public key corresponding to the private key used by the payment server 30 in generating the signature.

The data processing unit of the shop terminal 200 performs the signature verification process on the “(f) signature” read from the dynamic tag 210, according to a signature verification algorithm compliant with the public key cryptosystem, using the public key stored in the storage unit of the shop terminal 200.

In this signature verification process, in a case where validity of the signature is confirmed, it is determined that correct payment processing has been performed in the payment server 30.

In the signature verification process, in a case where validity of the signature is not confirmed, on the other hand, it is determined that correct payment processing has not been performed in the payment server 30. In this case, the shop terminal 200 outputs an error. For example, an error message is displayed on the display unit of the shop terminal 200. Alternatively, a warning alarm or the like is output.

In a case where

(1) confirmation of identical random numbers, and

(2) success of signature verification

are both recognized, the data processing unit of the shop terminal 200 determines that correct payment processing has been performed in the payment server 30, and moves on to the next process in step S112.

(Step S111)

In a case where it is determined that correct payment processing has been performed in the payment server 30 on the basis of the data verification process in step S110, the shop terminal 200 issues a payment completion notification in step S111.

For example, as described above with reference to FIG. 7, the message shown below is displayed on the display unit of the shop terminal 200.

“Payment is complete. Thank you.”

As the clerk of the shop 200 and the user 10 confirm this message, both sides can confirm that the payment has been correctly performed.

(Step S112)

The processing may be completed with the process in step S111, but the process described below may be performed at the end in step S112.

That is, in step S112, the shop terminal 200 transmits a payment completion message to the user terminal 100, to display the payment completion message on the user terminal 100.

As described above with reference to FIG. 8, for example, the message shown below is transmitted as a payment completion message from the shop terminal 200 to the user terminal 100, and is displayed on the user terminal 100.

“Payment of nnn yen has been completed by XYZ Pay. Thank you.”

With this message display, the user 10 can also confirm, on the user terminal 100, that the payment has been completed.

As is understood from the sequence diagram shown in FIGS. 10 and 11, the shop terminal 200 does not have the step of communicating directly with the payment server 30. All communications with the payment server 30 are conducted by the user terminal 100. Communications between the shop terminal 200 and the user terminal 100 are performed by data recording and reading using the dynamic tag 210.

That is, the shop terminal 200 does not need a process of communication via a network, and can be formed as a low-cost, small-sized device.

In the payment sequence of the present disclosure, the shop terminal 200 generates a random number, and transmits the random number to the payment server 30 via the dynamic tag 210 and the user terminal 100. The payment server 30 generates a random number and signature data corresponding to the random number after the payment processing, and transmits the generated data to the user terminal 100.

The shop terminal 200 receives an input of the transmission data from the payment server 30 via the user terminal 100 and the dynamic tag 210, and verifies the input data, to determine whether or not the payment processing in the payment server 30 has been correctly performed. As these processes are performed, the shop terminal 200 that does not have a function to communicate with the payment server 30 can accurately confirm whether or not correct payment processing has been performed, and thus, payment processing excluding fraudulent processing can be performed without fail.

[4. Specific Examples and Modifications of the Verification Process in the Shop Terminal]

Next, specific examples and modifications of the verification process in the shop terminal are described.

In step S111 in the sequence described above with reference to FIGS. 10 and 11, the shop terminal 200 performs a verification process on the random number transmitted by the payment server 30 and the signature data corresponding to the random number, and performs a process of confirming whether or not the payment processing has been correctly performed in the payment server 30.

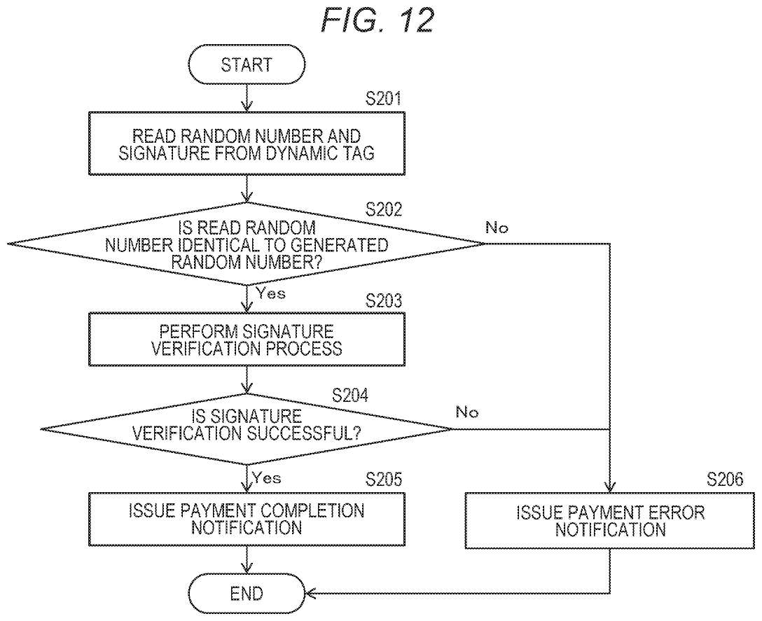

Referring now to a flowchart shown in FIG. 12, the process sequence of this verification process is described.

The processes according to the flowchart shown in FIG. 12 can be performed by a control unit (data processing unit) of the shop terminal according to a program stored in the storage unit. For example, the processes can be performed as program execution processes by a processor such as a CPU having a program execution function.

The processes in the respective steps in the flow shown in FIG. 12 are described below.

(Step S201)

In step S201, from the dynamic tag 210, the data processing unit of the shop terminal 200 reads the data written in the dynamic tag 210, which is a random number (Nonce) and a signature.

These pieces of data are data that has been received by the user terminal 100 from the payment server 30 and been written into the dynamic tag 210 by the user terminal 100.

(Step S202)

Next, in step S202, the data processing unit of the shop terminal 200 determines whether or not the random number (Nonce) read from the dynamic tag 210 has the same value as the random number generated earlier by the shop terminal 200.

As described above, the shop terminal 200 records and holds the random number generated by the shop terminal 200 in the storage unit in the shop terminal 200.

If the random number (nonce) read from the dynamic tag 210 does not have the same value as the random number generated by the shop terminal 200, the result of the determination in step S202 is No.

In this case, it is determined that correct payment processing by the payment server 30 has not been performed, and the process moves on to step S206.

If the random number (nonce) read from the dynamic tag 210 has the same value as the random number generated by the shop terminal 200, on the other hand, the result of the determination in step S202 is Yes.

In this case, the process moves on to step S203.

(Step S203)

In a case where identical random numbers are confirmed in step S202, the data processing unit of the shop terminal 200 next performs a signature verification process in step S203. This is a process of verifying the signature read from the dynamic tag 210.

This signature verification process is performed with the public key corresponding to the private key used by the payment server 30 in generating the signature. The storage unit of the shop terminal 200 stores the public key corresponding to the private key used by the payment server 30 in generating the signature.

The data processing unit of the shop terminal 200 performs the signature verification process on the signature read from the dynamic tag 210, according to a signature verification algorithm compliant with the public key cryptosystem, using the public key stored in the storage unit of the shop terminal 200.

(Step S204)

In step S204, a check is made to determine whether or not validity of the signature has been confirmed in the signature verification process in step S203, or whether or not the signature verification is successful.

If the signature verification is successful, and validity of the signature is confirmed, the process moves on to step S205.

If the signature verification is not successful, and validity of the signature is not confirmed, on the other hand, the process moves on to step S206.

(Step S205)

If the signature verification is successful, and validity of the signature is confirmed in step S204, the data processing unit of the shop terminal 200 issues a payment completion notification in step S205.

Specifically, the process of displaying the payment completion message described above with reference to FIGS. 7 and 8, and the like are performed, for example.

(Step S206)

The process in step S206 is performed in a case where the result of the determination in step S202 is No, or where the result of the determination in step S204 is No.

That is, if it is determined in step S202 that the random number (Nonce) read from the dynamic tag 210 does not have the same value as the random number generated by the shop terminal 200, or

if the signature verification is not successful, and validity of the signature is not confirmed in step S204,

the data processing unit of the shop terminal 200 performs the process in step S206.

In these cases, the data processing unit of the shop terminal 200 issues a payment error notification in step S206. For example, an error message is displayed on the display unit of the shop terminal 200. Alternatively, a warning alarm or the like is output.

Note that the data verification process according to the flowchart shown in FIG. 12 is an example, and the shop terminal 200 may perform data verification processes in other modes.

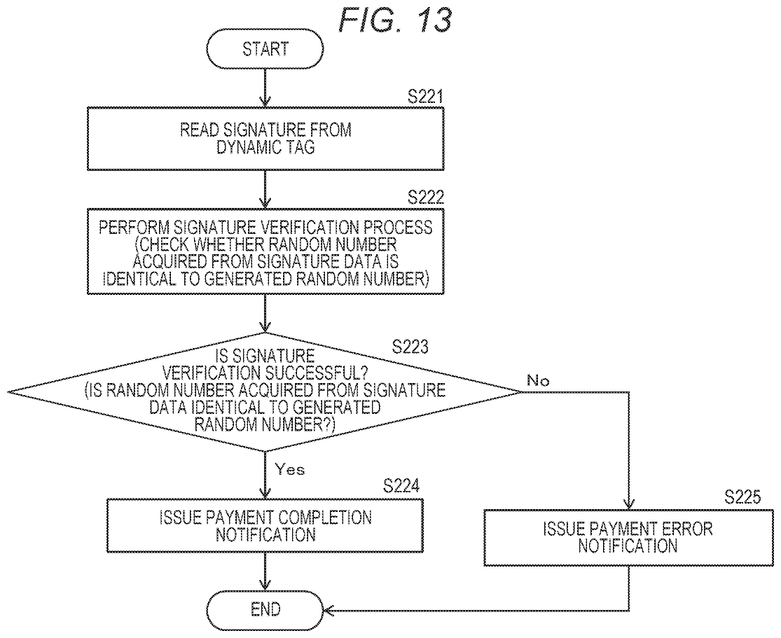

A flowchart shown in FIG. 13 is a data verification sequence in a case where the payment server 30 is designed to transmit only the signature data corresponding to a random number.

In the sequence diagram shown in FIGS. 10 and 11, the payment server 30 transmits a random number and the signature data corresponding to the random number to the user terminal 100. However, a random number may not be transmitted, and only the signature data corresponding to the random number may be transmitted from the payment server 30 to the user terminal 100.

In this case, the user terminal 100 writes only the signature data received from the payment server 30 into the dynamic tag 210, the signature data corresponding to the random number.

The shop terminal 200 reads only the signature data written in the dynamic tag 210 and performs a data verification process, the signature data corresponding to the random number.

Referring now to a flowchart shown in FIG. 13, the sequence of this data verification process is described.

The processes in the respective steps in the flow shown in FIG. 13 are described below.

(Step S221)

In step S221, from the dynamic tag 210, the data processing unit of the shop terminal 200 reads the data written in the dynamic tag 210, which is the signature data corresponding to a random number (Nonce).

These pieces of data are data that has been received by the user terminal 100 from the payment server 30 and been written into the dynamic tag 210 by the user terminal 100.

(Steps S222 and S223)

Next, in step S222, the data processing unit of the shop terminal 200 performs a process of verifying the signature read from the dynamic tag 210, the signature corresponding to the random number (Nonce).

The signature verification process is performed with the public key corresponding to the private key used by the payment server 30 in generating the signature. The storage unit of the shop terminal 200 stores the public key corresponding to the private key used by the payment server 30 in generating the signature.

The data processing unit of the shop terminal 200 performs the signature verification process on the signature read from the dynamic tag 210, according to a signature verification algorithm compliant with the public key cryptosystem, using the public key stored in the storage unit of the shop terminal 200.

The signature verification process performed on the signature with the use of the public key is a process that corresponds to an encrypted data decryption process to be performed on a random number with the use of a private key, and the random number can be acquired during the signature verification process.

The data processing unit of the shop terminal 200 determines whether or not the random number obtained by the signature data decryption process using the public key is identical to the random number generated earlier by the shop terminal.

The random number generated earlier by the shop terminal is the random number generated in step S102 in the sequence diagram in FIG. 10.

If the random number obtained by the signature data decryption process using the public key is determined to identical to the random number generated earlier by the shop terminal, the signature verification is determined to be successful. In this case, the result of the determination in step S223 is Yes, and the process moves on to step S224.

If the random number obtained by the signature data decryption process using the public key is determined not to be identical to the random number generated earlier by the shop terminal, on the other hand, the signature verification is determined not to be successful. In this case, the result of the determination in step S223 is No, and the process moves on to step S225.

(Step S224)

If the signature verification is successful, and validity of the signature is confirmed in steps S222 and S223, the data processing unit of the shop terminal 200 issues a payment completion notification in step S224.

Specifically, the process of displaying the payment completion message described above with reference to FIGS. 7 and 8, and the like are performed, for example.

(Step S225)

The process in step S225 is performed in a case where the signature verification is not successful and validity of the signature is not confirmed in steps S222 and S223.

In this case, the data processing unit of the shop terminal 200 issues a payment error notification in step S225. For example, an error message is displayed on the display unit of the shop terminal 200. Alternatively, a warning alarm or the like is output.

Further, the signature data generated by the payment server 30 may be signature data corresponding to all the data to be written into the dynamic tag 210 in step S102 in the sequence diagram in FIG. 10 described above.

Specifically, the data is:

(a) shop ID;

(b) shop terminal information (such as shop terminal ID);

(c) settlement amount (=payment amount); and

(d) random number (Nonce).

The payment server 30 may be designed to use the private key for all of these pieces of data (a) to (d) to generate a signature, and transmit the generated signature data to the user terminal 100.

In this case, the shop terminal 200 reads the signature data corresponding to all the above data (a) to (d) written into the dynamic tag 210 by the user terminal 100, and performs a data verification process.

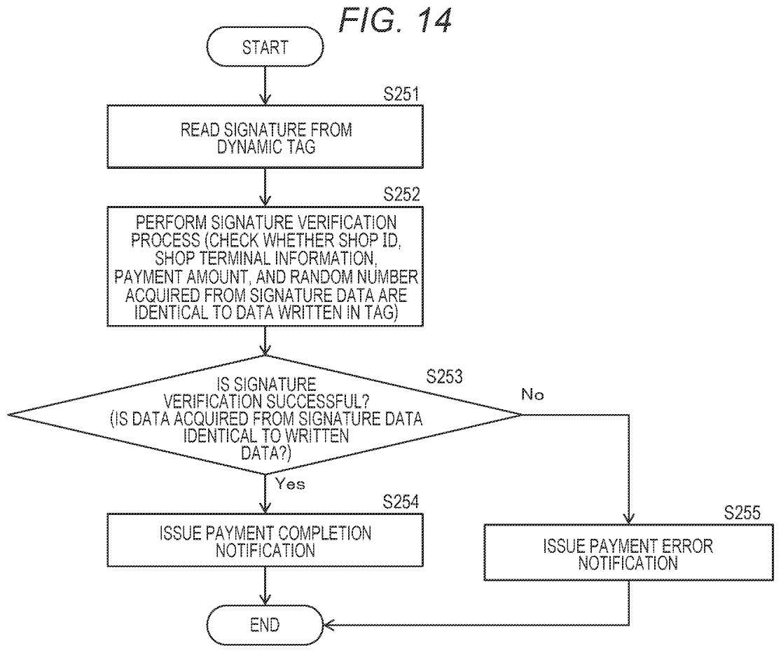

Referring now to a flowchart shown in FIG. 14, the sequence of this data verification process is described.

The processes in the respective steps in the flow shown in FIG. 14 are described below.

(Step S251)

In step S251, the data processing unit of the shop terminal 200 reads the data written in the dynamic tag 210, which is:

(a) shop ID;

(b) shop terminal information (such as shop terminal ID);

(c) settlement amount (=payment amount); and

(d) random number (Nonce).

The signature data corresponding to all of these pieces of data is read from the dynamic tag 210.

These pieces of data are data that has been received by the user terminal 100 from the payment server 30 and been written into the dynamic tag 210 by the user terminal 100.

(Steps S252 and S253)

Next, in step S252, the data processing unit of the shop terminal 200 performs a process of verifying the signature corresponding to all of the above data (a) to (d) read from the dynamic tag 210.

The signature verification process is performed with the public key corresponding to the private key used by the payment server 30 in generating the signature. The storage unit of the shop terminal 200 stores the public key corresponding to the private key used by the payment server 30 in generating the signature.

The data processing unit of the shop terminal 200 performs the signature verification process on the signature read from the dynamic tag 210, according to a signature verification algorithm compliant with the public key cryptosystem, using the public key stored in the storage unit of the shop terminal 200.

The process using the public key for the signature is a process that corresponds to a process of decrypting signature data that is encrypted data for which the private key has been used. As a result, the above decrypted data (a) to (d) can be acquired.

Through the signature data decryption process using the public key, the data processing unit of the shop terminal 200 acquires the following data:

(a) shop ID;

(b) shop terminal information (such as shop terminal ID);

(c) settlement amount (=payment amount); and

(d) random number (Nonce).

A check is made to determine whether or not these pieces of acquired data are identical to the data generated and written into the dynamic tag 210 earlier by the shop terminal.

The data generated and written into the dynamic tag 210 earlier by the shop terminal is the data generated and written into the dynamic tag 210 in step S102 in the sequence diagram in FIG. 10.

If the data obtained by the signature data decryption process using the public key is determined to be identical to the data generated and written into the dynamic tag 210 earlier by the shop terminal 200, the signature verification is determined to be successful. In this case, the result of the determination in step S253 is Yes, and the process moves on to step S254.

If the data obtained by the signature data decryption process using the public key is determined not to be identical to the data generated and written into the dynamic tag 210 earlier by the shop terminal 200, on the other hand, the signature verification is determined not to be successful. In this case, the result of the determination in step S253 is No, and the process moves on to step S255.

(Step S254) If the signature verification is successful, and validity of the signature is confirmed in steps S252 and S253, the data processing unit of the shop terminal 200 issues a payment completion notification in step S254.

Specifically, the process of displaying the payment completion message described above with reference to FIGS. 7 and 8, and the like are performed, for example.

(Step S255)

The process in step S255 is performed in a case where the signature verification is not successful and validity of the signature is not confirmed in steps S252 and S253.

In this case, the data processing unit of the shop terminal 200 issues a payment error notification in step S255. For example, an error message is displayed on the display unit of the shop terminal 200. Alternatively, a warning alarm or the like is output.

As described above, various modes can be adopted as modes of the signature data to be used in the process of determining whether or not correct payment processing has been performed in the payment server 30.

The payment server 30 can generate signature data corresponding to all or part of the data written into the dynamic tag 210 by the shop terminal 200, and transmit the signature data to the user terminal 100.

Depending on the configuration of this signature data, the signature verification process to be performed by the shop terminal 200 also varies.

[5. Example Configurations of the Respective Apparatuses]

Next, specific examples of the device configurations of the respective information processing apparatuses that are used in the payment processing system of the present disclosure are described. That is, specific examples of the device configurations of the user terminal 100, the shop terminal 200, and the payment server 30 are described.

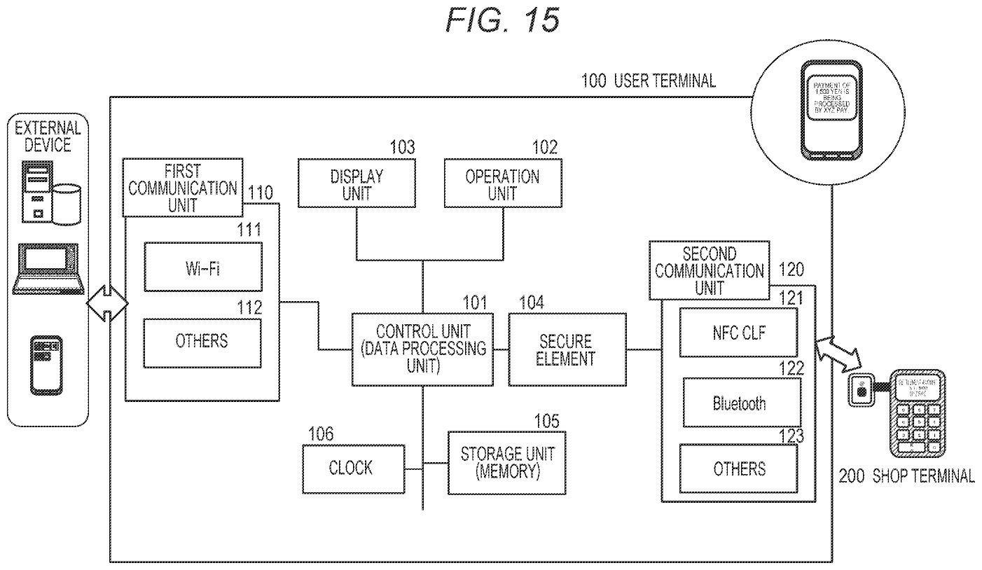

First, an example device configuration of the user terminal 100 is described with reference to FIG. 15.

The user terminal 100 is a smart phone (smartphone), for example, and has the configuration shown in FIG. 15, for example.

As shown in FIG. 15, the user terminal 100 includes a control unit (data processing unit) 101, an operation unit 102, a display unit 103, a secure element 104, a storage unit (memory) 105, a clock 106, a first communication unit 110, and a second communication unit 120.

The first communication unit 110 includes a Wi-Fi communication unit 111 and other communication units 112. The second communication unit 120 includes an NFC-CLF 121, a Bluetooth (registered trademark) communication unit 122, and other communication units 123.

The control unit (data processing unit) 101 performs control on the processes to be performed in the user terminal 100. Specifically, the process of writing data into the dynamic tag, the process of reading data, the communication with the payment server, and the like are controlled.

Note that the control programs to be executed by the control unit (data processing unit) 101, applications, and the like are stored in the storage unit (memory) 105.

The control unit (data processing unit) 101 includes a processor such as a CPU having a program execution function.

The operation unit 102 is an operation unit that can be operated by the user, and includes a touch panel or the like on the display unit 103, in addition to various switches. The user can input various kinds of information via the operation unit 102.

The display unit 103 is a display unit such as a liquid crystal display, for example, and is used to display information about execution of various applications and the like.

The secure element 104 is an IC chip that is formed as an element including a secure memory and a memory control unit. The secure memory in the secure element 104 stores a cashless payment function providing application and the like.

The control programs to be executed by the control unit 101, applications, ID information, user account information, and the like are recorded in the storage unit (memory) 105.

The clock 106 is time information, and outputs clock information to each processing unit.

The first communication unit 110 includes the Wi-Fi communication unit 111 and the other communication units 112, and is used for communicating with an external device such as a server, a PC, a smartphone, or a wearable device, for example. The other communication units 112 are communication units having telecommunication functions, such as a telephone line or the Internet.

The second communication unit 120 includes the NFC-CLF 121, the Bluetooth (registered trademark) communication unit 122, and the other communication units 123, and performs a process of communicating with the dynamic tag 210, for example. The other communication units 123 are communication units that perform near field communication, such as an RF communication unit.

The NFC-CLF 121 is a near field communication (NFC)-contactless front end (CLF), and is one of those IC chips for near field communication.

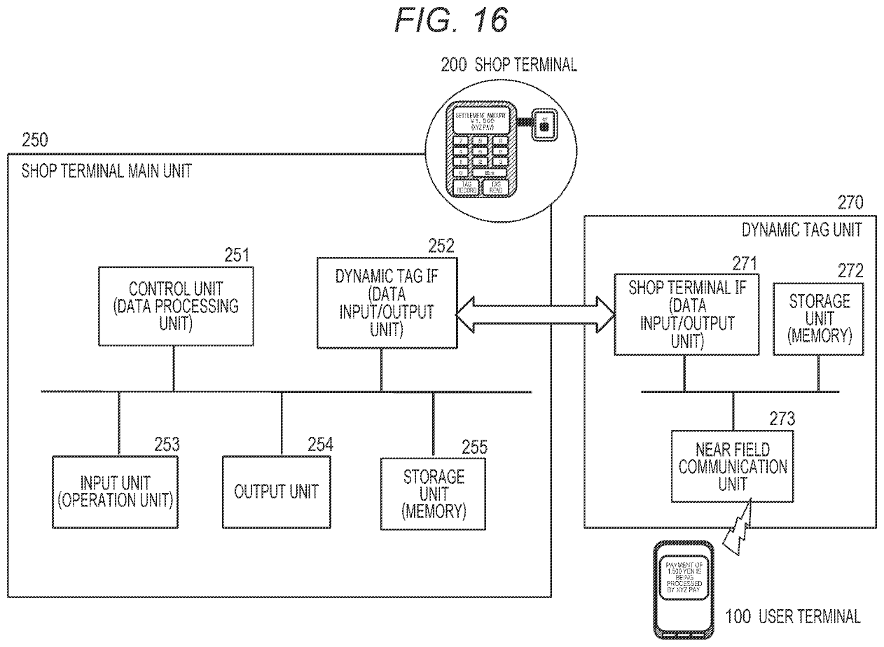

Next, an example configuration of the shop terminal 200 is described with reference to FIG. 16.

FIG. 16 is a block diagram showing an example configuration of the shop terminal 200.

The shop terminal 200 shown in FIG. 16 is illustrated as a terminal that includes a shop terminal main unit 250 and a dynamic tag unit 270 separately from each other.

The shop terminal main unit 250 and the dynamic tag unit 270 may be formed as separate components, or may be formed as an integrated component.

The example configuration shown in FIG. 16 is an example in which the shop terminal main unit 250 and the dynamic tag unit 270 are formed as separate components.

The shop terminal main unit 250 includes a control unit (data processing unit) 251, a dynamic tag interface (data input/output unit) 252, an input unit (operation unit) 253, an output unit 254, and a storage unit (memory) 255.

Meanwhile, the dynamic tag unit 270 includes a shop terminal interface (data input/output unit) 271, a storage unit (memory) 272, and a near field communication unit 273.

First, the components of the shop terminal main unit 250 are described.

The control unit (data processing unit) 251 performs overall control on the processes to be performed in the shop terminal main unit 250.

Specifically, the following processes are performed: control on the data write process and the data read process to be performed on the dynamic tag 270, a process of generating the data to be written into the dynamic tag 270, a random number generation process, a process of verifying data read from the dynamic tag 270, a signature verification process, and the like.

Note that the programs for performing these processes are stored in the storage unit (memory) 255. The control unit (data processing unit) 251 includes a processor such as a CPU having a program execution function.

The dynamic tag interface (data input/output unit) 252 is an interface for a process of outputting record data to the dynamic tag unit 270 and a process of reading data from the dynamic tag unit 270.

The input unit (operation unit) 253 is an input unit to be used by the user, and includes switches, buttons, and the like for inputting a settlement amount, recording data into the dynamic tag unit 270, and inputting a command or the like to read data from the dynamic tag unit 270, for example.

The output unit 254 includes a display unit, a sound output unit, and the like, for example. The output unit 254 displays a settlement amount, and outputs various messages, warnings, and the like.

The programs to be executed by the control unit (data processing unit) 251, the parameters to be used in executing the programs, and the like are recorded in the storage unit (memory) 255.

Further, the storage unit (memory) 255 is also used as the recording area for a generated random number, and the recording area for information such as the shop terminal ID, the shop terminal information, and the settlement amount.

Next, the components of the dynamic tag unit 270 are described.

The shop terminal interface (data input/output unit) 271 is an interface for outputting the data recorded in the storage unit (memory) 272 of the dynamic tag unit 270 to the shop terminal main unit 250, and inputting record data from the shop terminal main unit 250 to the dynamic tag unit 270.

The storage unit (memory) 272 is the recording area for the record data in the dynamic tag unit 210.

The near field communication unit 273 is a communication unit that performs near field communication with the user terminal 100, for example. For example, the near field communication unit 273 is formed with a NFC communication unit, a Bluetooth (registered trademark) communication unit, a RF communication unit, or the like.

Next, an example hardware configuration that can be used as the user terminal 100, the shop terminal 200, or the payment server 30 is described.

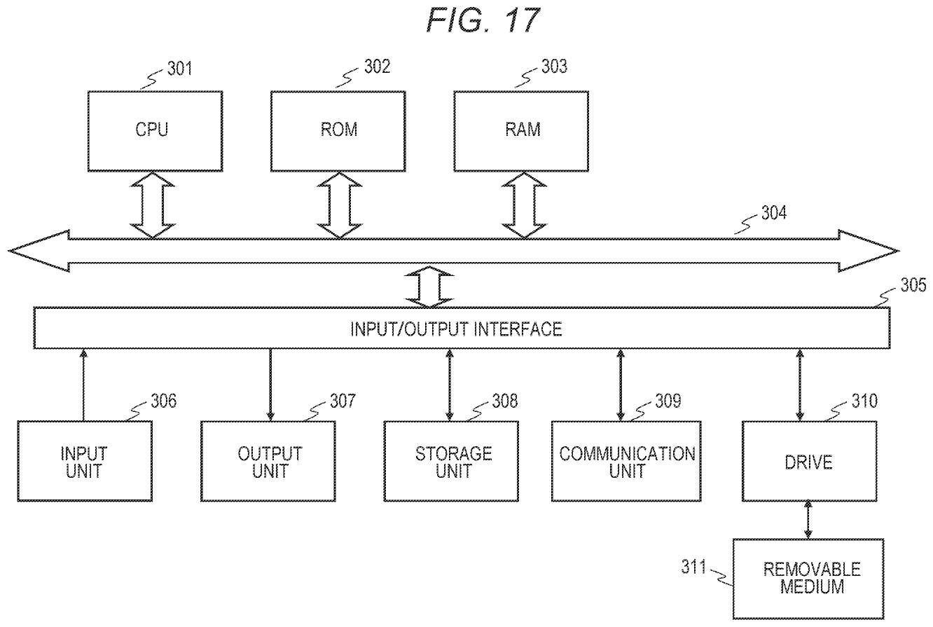

FIG. 17 is a diagram showing an example hardware configuration that can be used as the user terminal 100, the shop terminal 200, or the payment server 30.

The hardware configuration shown in FIG. 17 is now described.

A central processing unit (CPU) 301 functions as a control unit or a data processing unit that perform various kinds of processes in accordance with a program stored in a read only memory (ROM) 302 or a storage unit 308. For example, the processes according to the sequence described in the above embodiments are performed. The programs to be executed by the CPU 301, data, and the like are stored in a random access memory (RAM) 303. The CPU 301, the ROM 302, and the RAM 303 are connected to one another by a bus 304.

The CPU 301 is connected to an input/output interface 305 via the bus 304, and an input unit 306 formed with various kinds of switches, a keyboard, a mouse, a microphone, and the like, and an output unit 307 formed with a display, a speaker, and the like are also connected to the input/output interface 305. The CPU 301 performs various kinds of processes in accordance with instructions that are input through the input unit 306, and outputs processing results to the output unit 307, for example.

The storage unit 308 connected to the input/output interface 305 is formed with a flash memory, a hard disk, or the like, for example, and stores the programs to be executed by the CPU 301 and various kinds of data.

The component necessary in the communication unit 309 varies among the user terminal 100, the shop terminal 200, and the payment server 30.

The user terminal 100 includes a communication unit capable of performing both near field communication and telecommunication.

The payment server 30 does not need a near field communication function, and is only required to have a component capable of telecommunication.

The shop terminal 200 is only required to have a component capable of writing data into and reading data from a dynamic tag capable of near field communication.

A drive 310 connected to the input/output interface 305 drives a removable medium 311 such as a magnetic disk, an optical disk, a magnetooptical disk, or a semiconductor memory like a memory card, and performs recording or reading of data.

However, the shop terminal 200 does not necessarily include such components as the removable medium 311 and the drive 310.

[6. Summary of the Configuration of the Present Disclosure]

Embodiments of the present disclosure have been described so far by way of specific examples. However, it is obvious that those skilled in the art can make modifications to and substitutions of the embodiments without departing from the scope of the present disclosure. That is, the present disclosure is disclosed in the form of examples, and the above description should not be interpreted in a restrictive manner. The claims should be taken into account in understanding the subject matter of the present disclosure.

Note that the technology disclosed in this specification may also be embodied in the configurations described below.

(1) An information processing apparatus including

a data processing unit that performs a data write process and a data read process on a dynamic tag in which data is rewritable,

in which the data processing unit

writes payment data including a settlement amount and a random number into the dynamic tag, and

confirms that payment processing has been performed, by verifying a signature generated by a payment server, the signature having been written into the dynamic tag by a user terminal after the payment processing in the payment server.

(2) The information processing apparatus according to (1), in which

the dynamic tag has a near field communication function, and

is capable of performing near field communication with the user terminal.

(3) The information processing apparatus according to (1) or (2), in which the payment data recorded in the dynamic tag is transmitted to the payment server via the user terminal.

(4) The information processing apparatus according to any one of (1) to (3), in which the data processing unit performs a process of generating a random number and writing the random number into the dynamic tag every time payment processing is performed.

(5) The information processing apparatus according to any one of (1) to (4), in which the data processing unit confirms that payment processing has been performed, by verifying a random number and the signature received from the payment server, the random number and the signature having been written into the dynamic tag by the user terminal after the payment processing in the payment server.

(6) The information processing apparatus according to any one of (1) to (5), in which the data processing unit verifies a signature generated with a private key by the payment server, using a public key corresponding to the private key.

(7) The information processing apparatus according to any one of (1) to (6), in which, in verification of the signature, when the verification is successful, and it is confirmed that the payment processing has been correctly performed, the data processing unit performs a payment completion notification process.

b (8) The information processing apparatus according to any one of (1) to (7), in which, in verification of the signature, when the verification is not successful, and it is not confirmed that the payment processing has been correctly performed, the data processing unit performs a payment error notification process.

(9) The information processing apparatus according to any one of (1) to (8), in which the dynamic tag is integrated with the information processing apparatus, or is connected to the information processing apparatus in a wired or wireless manner.

(10) The information processing apparatus according to any one of (1) to (9), in which

the data processing unit writes the payment data into the dynamic tag, the payment data including a shop ID of a shop in which the information processing apparatus is installed, and information about a shop terminal corresponding to the information processing apparatus, and

the payment data including the shop ID and the information about the shop terminal is transmitted to the payment server via the dynamic tag and the user terminal.

(11) A payment processing system including:

a shop terminal that performs a data write process and a data read process on a dynamic tag in which data is rewritable;

a user terminal that performs a data write process and a data read process on the dynamic tag, and performs communication with a payment server; and

the payment server that performs communication with the user terminal,

in which the shop terminal writes payment data including a settlement amount and a random number into the dynamic tag,

the user terminal transmits the payment data recorded in the dynamic tag to the payment server,

the payment server generates and transmits a signature to the user terminal, after payment processing based on the payment data,

the user terminal writes the signature received from the payment server into the dynamic tag, and

the shop terminal verifies the signature written into the dynamic tag by the user terminal, and confirms that the payment processing has been performed.

(12) The payment processing system according to (11), in which, in addition to the payment data recorded in the dynamic tag, the user terminal transmits user account information to the payment server, the user account information being necessary in the payment processing.

(13) The payment processing system according to (11) or (12), in which

the dynamic tag has a near field communication function, and

is capable of performing near field communication with the user terminal.

(14) The payment processing system according to any one of (11) to (13), in which the shop terminal performs a process of generating a random number and writing the random number into the dynamic tag every time payment processing is performed.

(15) The payment processing system according to any one of (11) to (14), in which

the payment server generates the signature, using a private key of the payment server, and

the shop terminal performs verification, using a public key corresponding to the private key.

(16) An information processing method implemented in an information processing apparatus,

the information processing apparatus including

a data processing unit that performs a data write process and a data read process on a dynamic tag in which data is rewritable,

in which the data processing unit

writes payment data including a settlement amount and a random number into the dynamic tag, and

confirms that payment processing has been performed, by verifying a signature generated by a payment server, the signature having been written into the dynamic tag by a user terminal after the payment processing in the payment server.

(17) A payment processing method implemented in a payment processing system that includes:

a shop terminal that performs a data write process and a data read process on a dynamic tag in which data is rewritable;

a user terminal that performs a data write process and a data read process on the dynamic tag, and performs communication with a payment server; and

the payment server that performs communication with the user terminal,

in which the shop terminal writes payment data including a settlement amount and a random number into the dynamic tag,

the user terminal transmits the payment data recorded in the dynamic tag to the payment server,

the payment server generates and transmits a signature to the user terminal, after payment processing based on the payment data,

the user terminal writes the signature received from the payment server into the dynamic tag, and

the shop terminal verifies the signature written into the dynamic tag by the user terminal, and confirms that the payment processing has been performed.

(18) A program for causing an information processing apparatus to perform information processing,

the information processing apparatus including

a data processing unit that performs a data write process and a data read process on a dynamic tag in which data is rewritable,

the program causing the data processing unit to perform:

a process of writing payment data including a settlement amount and a random number into the dynamic tag; and

a process of confirming that payment processing has been performed, by verifying a signature generated by a payment server, the signature having been written into the dynamic tag by a user terminal after the payment processing in the payment server.

Further, the series of processes described in this specification can be performed by hardware, software, or a combination of hardware and software. In a case where processes are performed by software, a program in which the process sequences are recorded may be installed into a memory incorporated into special-purpose hardware in a computer that executes the program, or may be installed into a general-purpose computer that can perform various kinds of processes and execute the program. For example, the program can be recorded beforehand into a recording medium. The program can be installed from a recording medium into a computer, or can be received via a network such as a local area network (LAN) or the Internet and be installed into a recording medium such as an internal hard disk.

Note that the various processes described in this specification may not be performed in chronological order according to the description, but may be performed in parallel or independently of one another depending on the processing capability of the device performing the processes or as necessary. Also, in this specification, a system is a logical assembly of a plurality of devices, and does not necessarily mean devices with respective components incorporated into the same housing.

### INDUSTRIAL APPLICABILITY

As described so far, according to the configuration of one embodiment of the present disclosure, even in a case where a shop terminal does not have a function to communicate with a payment server, reliable payment processing can be performed while fraudulent processing is prevented.

Specifically, for example, in a payment processing system including a shop terminal and a user terminal that perform a data write process and a data read process on a data-rewritable dynamic tag, and a payment server that performs communication with the user terminal, the shop terminal writes payment data including a settlement amount and a random number into the dynamic tag. The user terminal transmits the payment data recorded in the dynamic tag to the payment server, the payment server generates a signature and transmits the signature to the user terminal after the payment processing, and the user terminal writes the signature into the dynamic tag. After that, the shop terminal verifies the signature written into the dynamic tag by the user terminal, and confirms that the payment processing has been performed.

With this configuration, even in a case where a shop terminal does not have a function to communicate with a payment server, reliable payment processing can be pe6rformed while fraudulent processing is prevented.

### REFERENCE SIGNS LIST

10 User

11 User terminal

20 Shop

21, 24 Code information

22 Shop terminal

30 Payment server

100 User terminal

101 Control unit (data processing unit)

102 Operation unit

103 Display unit

104 Secure element

105 Storage unit (memory)

106 Clock

110 First communication unit

111 Wi-Fi communication unit

112 Other communication units

120 Second communication unit

121 NFC-CLF

122 Bluetooth (registered trademark) communication unit

123 Other communication units

200 Shop terminal

210 Dynamic tag

250 Shop terminal main unit

251 Control unit (data processing unit)

252 Dynamic tag interface (data input/output unit)

253 Input unit (operation unit)

254 Output unit

255 Storage unit (memory)

270 Dynamic tag unit

271 Shop terminal interface (data input/output unit)

272 Storage unit (memory)

273 Near field communication unit

301 CPU

302 ROM

303 RAM

304 Bus

305 Input/output interface

306 Input unit

307 Output unit

308 Storage unit

309 Communication unit

310 Drive

311 Removable medium

1. An information processing apparatus comprising
a data processing unit that performs a data write process and a data read process on a dynamic tag in which data is rewritable,
wherein the data processing unit
writes payment data including a settlement amount and a random number into the dynamic tag, and
confirms that payment processing has been performed, by verifying a signature generated by a payment server, the signature having been written into the dynamic tag by a user terminal after the payment processing in the payment server.

2. The information processing apparatus according to claim 1, wherein
the dynamic tag has a near field communication function, and
is capable of performing near field communication with the user terminal.

3. The information processing apparatus according to claim 1, wherein the payment data recorded in the dynamic tag is transmitted to the payment server via the user terminal.

4. The information processing apparatus according to claim 1, wherein the data processing unit performs a process of generating a random number and writing the random number into the dynamic tag every time payment processing is performed.

5. The information processing apparatus according to claim 1, wherein the data processing unit confirms that payment processing has been performed, by verifying a random number and the signature received from the payment server, the random number and the signature having been written into the dynamic tag by the user terminal after the payment processing in the payment server.

6. The information processing apparatus according to claim 1, wherein the data processing unit verifies a signature generated with a private key by the payment server, using a public key corresponding to the private key.

7. The information processing apparatus according to claim 1, wherein, in verification of the signature, when the verification is successful, and it is confirmed that the payment processing has been correctly performed, the data processing unit performs a payment completion notification process.

8. The information processing apparatus according to claim 1, wherein, in verification of the signature, when the verification is not successful, and it is not confirmed that the payment processing has been correctly performed, the data processing unit performs a payment error notification process.

9. The information processing apparatus according to claim 1, wherein the dynamic tag is integrated with the information processing apparatus, or is connected to the information processing apparatus in a wired or wireless manner.

10. The information processing apparatus according to claim 1, wherein
the data processing unit writes the payment data into the dynamic tag, the payment data including a shop ID of a shop in which the information processing apparatus is installed, and information about a shop terminal corresponding to the information processing apparatus, and
the payment data including the shop ID and the information about the shop terminal is transmitted to the payment server via the dynamic tag and the user terminal.

11. A payment processing system comprising:
a shop terminal that performs a data write process and a data read process on a dynamic tag in which data is rewritable;
a user terminal that performs a data write process and a data read process on the dynamic tag, and performs communication with a payment server; and
the payment server that performs communication with the user terminal,
wherein the shop terminal writes payment data including a settlement amount and a random number into the dynamic tag,
the user terminal transmits the payment data recorded in the dynamic tag to the payment server,
the payment server generates and transmits a signature to the user terminal, after payment processing based on the payment data,
the user terminal writes the signature received from the payment server into the dynamic tag, and
the shop terminal verifies the signature written into the dynamic tag by the user terminal, and confirms that the payment processing has been performed.

12. The payment processing system according to claim 11, wherein, in addition to the payment data recorded in the dynamic tag, the user terminal transmits user account information to the payment server, the user account information being necessary in the payment processing.

13. The payment processing system according to claim 11, wherein
the dynamic tag has a near field communication function, and
is capable of performing near field communication with the user terminal.

14. The payment processing system according to claim 11, wherein the shop terminal performs a process of generating a random number and writing the random number into the dynamic tag every time payment processing is performed.

15. The payment processing system according to claim 11, wherein
the payment server generates the signature, using a private key of the payment server, and
the shop terminal performs verification, using a public key corresponding to the private key.

16. An information processing method implemented in an information processing apparatus,
the information processing apparatus including
a data processing unit that performs a data write process and a data read process on a dynamic tag in which data is rewritable,
wherein the data processing unit writes payment data including a settlement amount and a random number into the dynamic tag, and confirms that payment processing has been performed, by verifying a signature generated by a payment server, the signature having been written into the dynamic tag by a user terminal after the payment processing in the payment server.

17. A payment processing method implemented in a payment processing system that includes:
a shop terminal that performs a data write process and a data read process on a dynamic tag in which data is rewritable;
a user terminal that performs a data write process and a data read process on the dynamic tag, and performs communication with a payment server; and
the payment server that performs communication with the user terminal,
wherein the shop terminal writes payment data including a settlement amount and a random number into the dynamic tag,
the user terminal transmits the payment data recorded in the dynamic tag to the payment server,
the payment server generates and transmits a signature to the user terminal, after payment processing based on the payment data,
the user terminal writes the signature received from the payment server into the dynamic tag, and
the shop terminal verifies the signature written into the dynamic tag by the user terminal, and confirms that the payment processing has been performed.

18. A program for causing an information processing apparatus to perform information processing,
the information processing apparatus including
a data processing unit that performs a data write process and a data read process on a dynamic tag in which data is rewritable,
the program causing the data processing unit to perform:
a process of writing payment data including a settlement amount and a random number into the dynamic tag; and
a process of confirming that payment processing has been performed, by verifying a signature generated by a payment server, the signature having been written into the dynamic tag by a user terminal after the payment processing in the payment server.
